(19) United States
(12) Patent Application Publication
(10) Pub. No.: US 2026/0299934 A1
(43) Pub. Date: Oct. 1, 2026

(54) AI-POWERED SYSTEM FOR MIGRATION AND UPGRADES OF ENTERPRISE ASSETS

(71) Applicant: TEACHERS INSURANCE AND ANNUITY ASSOCIATION OF AMERICA, New York, NY (US)

(72) Inventors: Sastry Vsm Durvasula, Phoenix, AZ (US); Swatee Singh, Livingston, NJ (US); Rares Ioan Almasan, Phoenix, AZ (US); Sonam Jha, Skillman, NJ (US); Thomas Matthew Verutes, Rockville Centre, NY (US); Sriram Venkatesan, Princeton Junction, NJ (US); Shafiq N. Kassam, Lewisville, TX (US)

(21) Appl. No.: 19/092,969

(22) Filed: Mar. 27, 2025

(51) Int. Cl. G06F 8/70

(52) U.S. Cl. CPC G06F 8/70

(57) ABSTRACT

Systems and methods for automating migration or upgrades of software applications are disclosed, which may comprise three different stages: a preparatory stage, an implementation stage, and a post-implementation stage. The preparatory stage may process one or more input data sets to one or more preprocessed data sets. The implementation stage may comprise utilizing the one or more preprocessed data sets to determine a conversion plan. The post-implementation stage may generate information regarding the conversion or the new application based upon the conversion plan.

### FIELD OF THE INVENTION

The present aspects relate to systems and methods for automating the migration and upgrade processes of software applications and/or hardware assets within enterprise computing environments. More particularly, these aspects provide a framework to assess, plan, execute, and manage migration activities, ensuring seamless transitions and minimizing disruptions.

### BACKGROUND

Migrating and upgrading software applications and/or hardware assets within an enterprise computing environment are critical yet complex processes. These activities often require significant time, effort, and specialized expertise due to the intricate dependencies between systems, data, and infrastructure. Despite the importance of such migrations, organizations frequently rely on manual or manually configured semi-automated methods, which are prone to errors, inefficiencies, and increased operational risk. Accordingly, there exists a need for an intelligent, automated solution that addresses these shortcomings by assessing, planning, executing, and managing the migration stages of software application and hardware upgrades.

### BRIEF SUMMARY OF THE INVENTION

According to various aspects described in further detail below, the techniques described herein relate to systems, methods, and computer-readable media storing instructions for automating migration or upgrades of software applications. In some aspects, a method may include a preparatory stage, an implementation stage, and/or a post-implementation stage. The preparatory stage may include obtaining one or more input data sets including data associated with an existing application and, for each of a plurality of artificial intelligence (AI) preprocessor modules, processing at least one of the one or more input data sets into a corresponding preprocessed data set using one or more preparatory AI models associated with the respective AI data preprocessor modules. The implementation stage may include generating a conversion plan for a conversion of the existing application to a new application by applying one or more implementation AI models to the plurality of preprocessed data sets, which conversion plan may include at least an architecture framework associated with the new application and a timeline for the conversion. The post-implementation stage may include generating information regarding the conversion or the new application based upon the conversion plan.

The data may include any of the following: technical documentation associated with the existing application, resource profile data associated with the existing application, security data associated with the existing application, resource technical debt data, a software correction log, a data conversion incident log, and/or external conversion data.

In some aspects, the preparatory stage may further include determining pattern identifications of past conversions of different resources including at least a pattern identification of a past conversion of the existing application and an impact assessment by applying an integration AI models to the one or more preprocessed data sets. Additionally or alternatively, the preparatory stage may further include identifying a plurality of dependencies of the existing application. The conversion plan may be based in part upon the plurality of dependencies.

In some aspects, generating the conversion plan may include generating an architecture framework associated with the new application by applying the one or more implementation AI models to the one or more preprocessed data sets, the pattern identification, and/or the impact assessment. In further aspects, the conversion plan may further include a conversion timeline laying out a sequence of tasks required for the conversion, and each respective task of the sequence of tasks may have an associated time. In still further aspects, the conversion plan may further include a conversion resource management plan based on past network traffic data of the existing application. In some further aspects, the conversion plan may further include a conversion testing plan to validate the conversion by a sequence of validation actions.

In some aspects, generating the information may include generating the information regarding the conversion or the new application by applying one or more release AI models to the one or more preprocessed data sets and the conversion plan. In further aspects, the information may further include alert procedures and maintenance procedures. In further aspects, the techniques may further include transmitting alert notifications according to the alert procedures.

In some aspects, the techniques may further include generating a communication agent by applying a chatbot AI model to the information, the conversion plan, and/or the one or more preprocessed data sets. The communication agent may include a plurality of different communication modes for different users. The techniques may then employ the communication agent to a user query regarding the conversion to generate a response.

In some aspects, the implementation stage may further include executing a plurality of steps of the conversion plan to migrate or upgrade the existing application to the new application on one or more computing devices.

In some aspects, at least one of the AI preprocessors modules may include a classifier AI model to classify the corresponding at least one input data set and a generative AI model to generate the corresponding preprocessed data set as a codified set of data for analysis by the one or more implementation AI models.

Systems or computer-readable media storing instructions for implementing all or part of the methods described above may also be provided in some aspects. Such systems or computer-readable media may include executable instructions to cause one or more processors to implement part or all of the methods described above. The systems, methods, and instructions disclosed herein may be implemented by one or more servers, client computing devices, enterprise computing devices, or combinations thereof. Additional or alternative features described herein below may be included in some aspects.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof.

FIG. 1 depicts a block diagram of an exemplary computing environment for automating migration or upgrades according to some embodiments.

FIG. 2 depicts an overarching block flow diagram of an example computer-implemented method utilizing a preparatory module, an implementation module, and a post implementation module for application migration and upgrades according to some embodiments.

FIG. 3A depicts a block flow diagram of a preprocessing stage of processing technical documentation associated with an existing application according to some embodiments.

FIG. 3B depicts a block flow diagram of a preprocessing stage of processing resource profile data (e.g., asset data) associated with the existing application according to some embodiments.

FIG. 3C depicts a preprocessing stage of processing data conversion incident log (e.g., incident reports) associated with the existing application according to some embodiments.

FIG. 3D depicts a preprocessing stage of processing a software correction log (e.g., past bug fixes) associated with the existing application according to some embodiments.

FIG. 3E depicts a preprocessing stage of processing security data associated with the existing application according to some embodiments.

FIG. 3F depicts a preprocessing stage of processing external conversion data (e.g., external documentation) associated with the existing application according to some embodiments.

FIG. 4 depicts a preparatory stage of preparing and assessing preprocessed data from the preprocessing stage associated with the existing application according to some embodiments.

FIG. 5 depicts a block flow diagram of an implementation stage according to some embodiments.

FIG. 6 depicts a block flow diagram of a post-implementation stage according to some embodiments.

FIG. 7 depicts a block diagram of displaying outputs according to some embodiments.

FIG. 8 depicts a computer-implemented method comprising a preparatory stage, an implementation stage, and a post-implementation stage for automating migration or upgrades according to some embodiments.

### DETAILED DESCRIPTION

The systems, methods, and techniques for automating the migration or upgrade process described herein provide significant advantages over traditional manual or manually configured semi-automated approaches, such as by ensuring higher efficiency, reliability, and scalability. One key advantage is the ability to integrate multiple data inputs, such as technical documentation, incident logs, and project management details, to create a comprehensive and informed conversion plan. By leveraging advanced artificial intelligence (AI) models, including generative AI and reinforcement learning, the disclosed techniques minimize human error, accelerate decision-making, and ensure that all aspects of the migration or upgrade are thoroughly addressed. The result is a streamlined process that reduces the time and resources required to execute complex transitions.

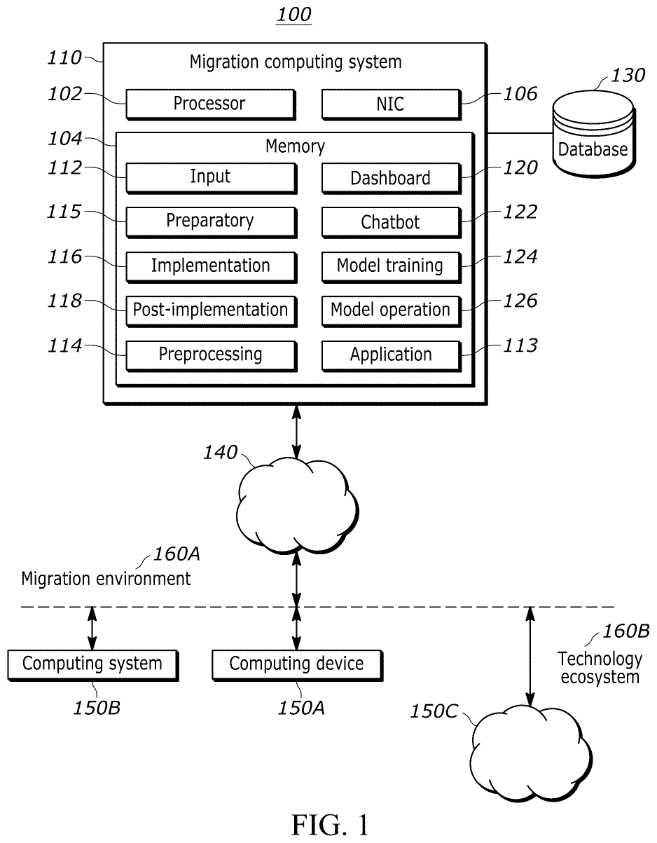

FIG. 1 depicts a block diagram of an exemplary computing environment 100 for automating migration or upgrades of software applications, according to some embodiments. Although the systems and methods disclosed herein may refer to migrations or upgrades to applications or software applications in order to aid concise description, it should be understood that the same systems and methods may be used to migrate or upgrade hardware components or other systems or computing or data infrastructure. The computing environment 100 may include a migration computing system 110 of a migration environment 160A communicatively coupled via a network 140 to one or more computing devices 150A, computing systems 150B, and/or a computing networks 150C of technology ecosystems 160B.

The migration computing system 110 may include a processor 102, a memory 104, and a network interface controller (NIC) 106. The processor 102 may include any number of processors and/or processor types, such as central processing units (CPUs), graphics processing units (GPUs), field-programmable gate arrays (FPGAs), application-specific integrated circuits (ASICs), digital signal processors (DSPs), neural processing units, RISC-V processors, coprocessors, specialized processors/accelerators for artificial intelligence (AI) or machine learning (ML)-specific applications, one or more microcontrollers, and the like. Generally, the processor is configured to execute instructions stored in the memory 104.

The memory 104 may include volatile and/or non-volatile fixed and/or removable memory, such as read-only memory (ROM), electronic programmable read-only memory (EPROM), random access memory (RAM), erasable electronic programmable read-only memory (EEPROM), and/or other hard drives, flash memory, solid-state drives, optical drives, MicroSD cards, and others. The memory 104 may have stored thereon one or more sets of processor-executable instructions.

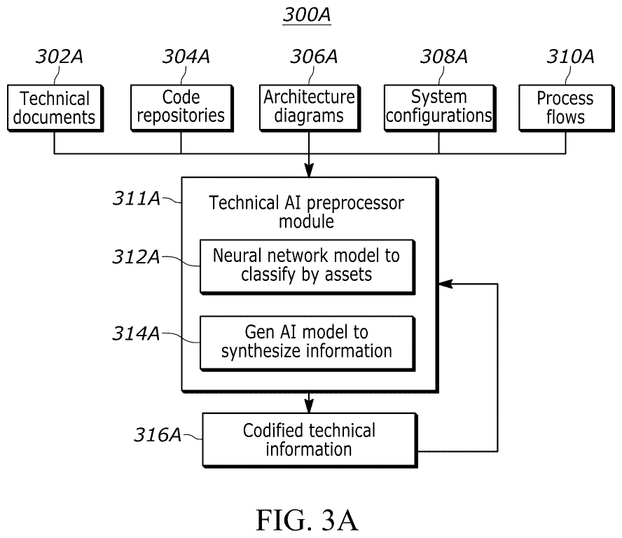

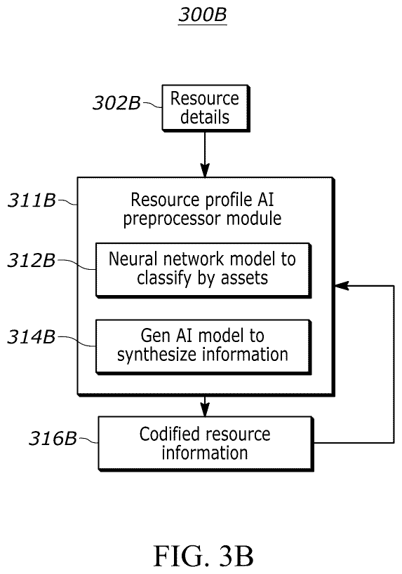

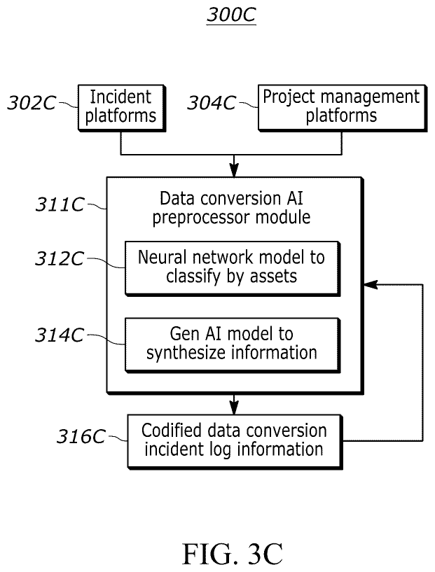

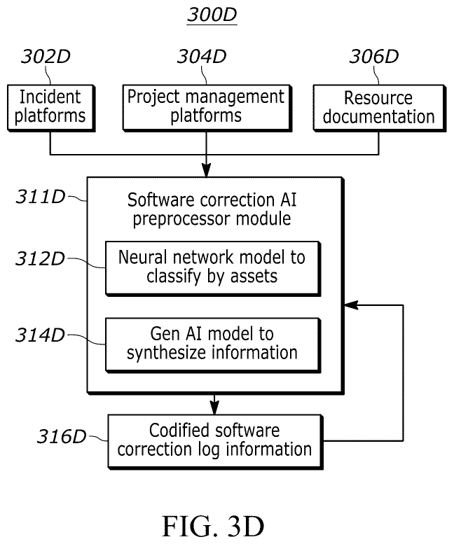

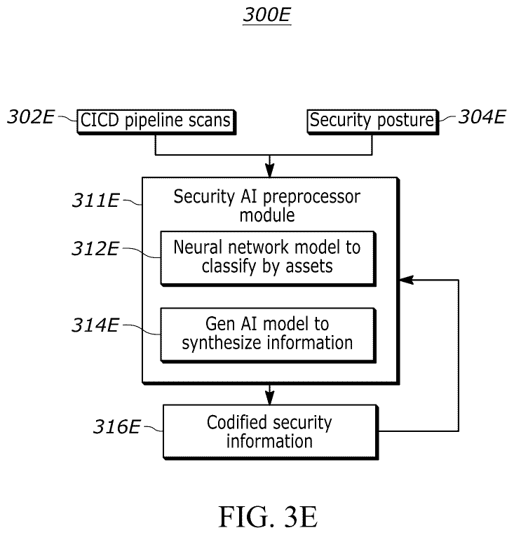

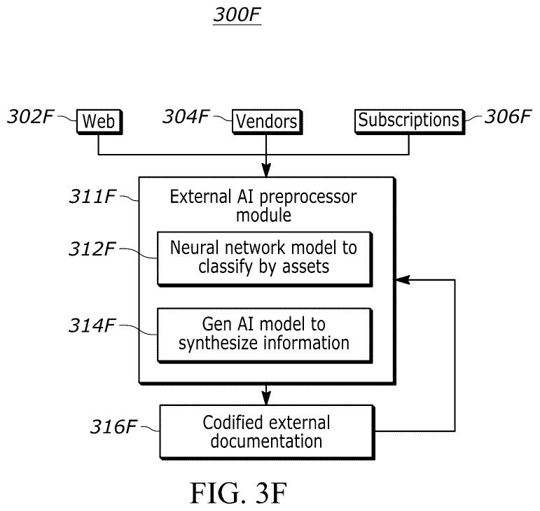

The memory 104 may include instructions for implementing a plurality of modules, each module comprising a respective set of processor-executable instructions for performing various sets of functions. An input module 112 may obtain input data from multiple sources, including input data associated with technical documentation (e.g., technical documents, code repositories, architecture diagram, system configurations, process flows), input data associated with resource profile data (e.g., asset details), input data associated with security data (e.g., continuous integration/continuous delivery (CI/CD) pipeline scans or security posture), input data associated with resource technical debt data, input data associated with a software correction log (e.g., incident platform data, project management platform data, or other asset documentations), input data associated with data conversion incident log (e.g., incident platforms data or project management platforms data), and input data associated with external conversion data (e.g., web data, vendor data, or subscription data). In some embodiments, users of the computing device 150A may provide the input data to the migration computing system 110 through the network 140. These input data may all be associated with an existing application, and exemplary input data are further described in relation to FIG. 3A-3F.

The application 113 may include an existing software application that the migration computing system 110 is trying to migrate or upgrade. These migration or upgrade efforts may be necessitated by various scenarios, such as version upgrades to maintain compatibility with modern systems, solution upgrades to integrate new features or functionalities, or the decommissioning of outdated tools. For instance, the migration computing system 110 may handle scenarios where an application is transitioning from an on-premises deployment to a cloud-based platform, adapting to microservices architecture from a monolithic framework, or upgrading to meet new security and compliance standards. Additionally, the migration may involve replacing obsolete technologies or integrating alternative tools to meet evolving business requirements.

As an illustrative example, the application 113 could be a platform or software application designed to host and manage various resources (e.g., assets). For instance, in a financial services context, the application 113 might provide functionalities for tracking fund performance, managing investments, and ensuring regulatory compliance. In this case, the migration could involve transitioning from an older platform (e.g., existing software application) with limited scalability to a modernized, cloud-native platform capable of handling more complex analytics, real-time updates, and enhanced security.

A preprocessing module 114 may utilize neural networks, generative artificial intelligence models, reinforcement learning with human feedback, and/or other models or data processing techniques, to preprocess the input data 112 to generate preprocessed data that are structured or codified. These preprocessed data may be classified and optimized for downstream analysis and conversion by other system modules. The preprocessing module 114 may comprise a plurality of preprocessor modules, each preprocessor module designed to train and output different types of codified dataset. For example, the preprocessing module 114 may convert the input data associated with technical documentation (e.g., technical documents, code repositories, architecture diagram, system configurations, and process flows) into a codified technical documentation. Details and exemplary embodiments of preprocessing are further discussed below in relation to FIG. 3A-3F.

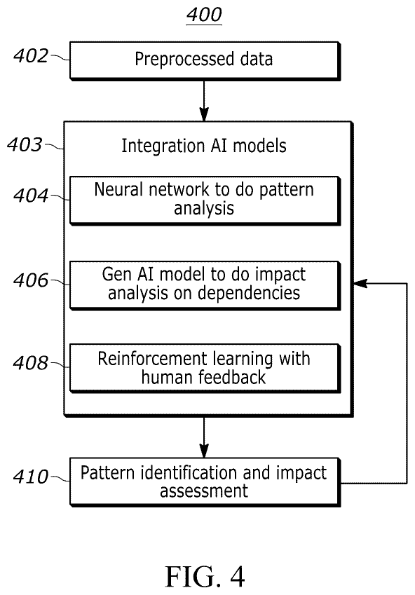

A preparatory module 115 may use the plurality of preprocessed data to determine pattern identifications of past conversions of different resources including at least a pattern identification of a past conversion of the existing application and an impact assessment to identify dependencies of the existing application. Similarly, the preparatory module 115 may utilize neural networks, generative artificial intelligence models, reinforcement learning with human feedback, and/or other models or data processing techniques. By synthesizing the preprocessed data into actionable insights, the preparatory module 115 establishes a robust foundation for the subsequent stages of the migration or upgrade process. Details and exemplary embodiments of the assessment of the preparatory module 115 are further discussed below in relation to FIG. 4.

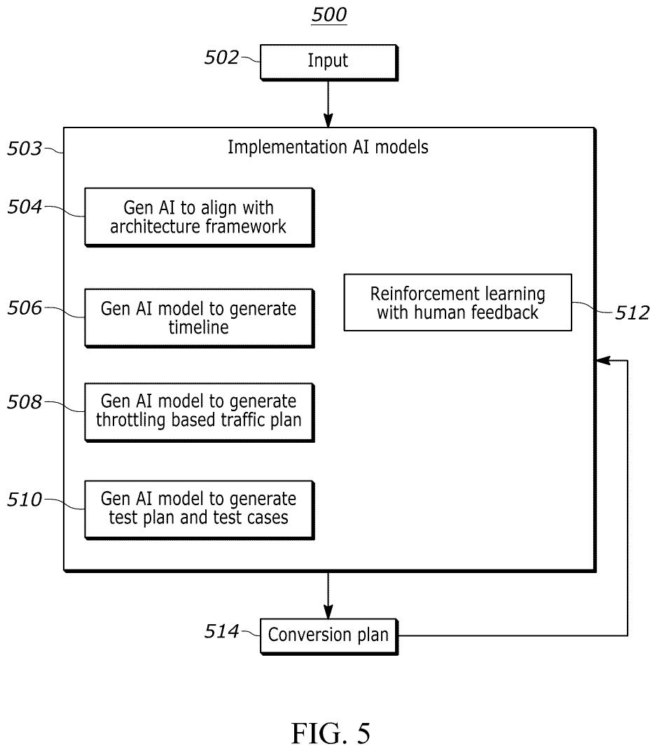

An implementation module 116 may use the pattern identification of the past conversion, the impact assessment, and/or the plurality of preprocessed data to determine a conversion plan of the existing application to a new application. Similarly, the implementation module 116 may utilize neural networks, generative artificial intelligence models, reinforcement learning with human feedback, and/or other models or data processing techniques. The conversion plan may comprise an architecture framework associated with the new application, the conversion timeline for the migration or the upgrade, conversion resource management of the migration, conversion testing plans for the migration or the upgrade, etc. Details exemplary embodiments of determining the conversion plan are further discussed below in relation to FIG. 5.

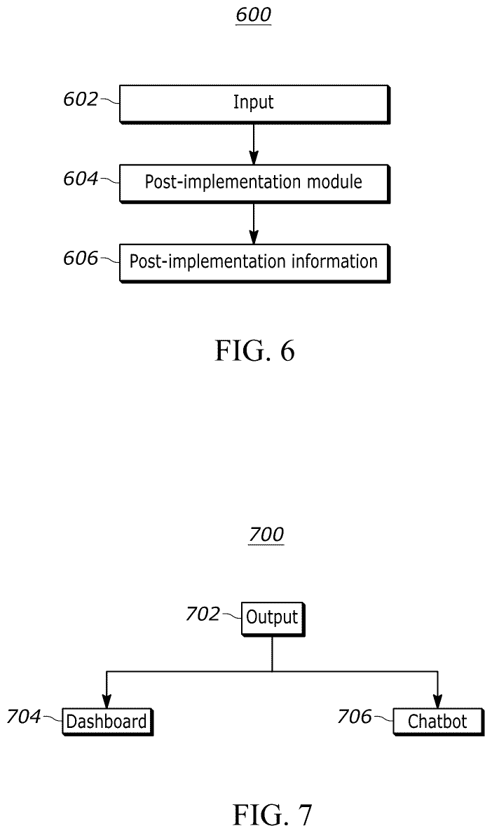

A post-implementation module 118 may, upon determining the conversion plan by the implementation module 116, generate information (e.g., notifications, maintenance notices, release notes) and transmit the information to one or more respective computing system 150B, computing device 150A, etc. associated with the conversion plan. The post-implementation module 118 may utilize the dependencies or details in the conversion plan to generate and/or release information associated with the conversion plan. In some embodiments, the post-implementation module 118 may be a machine learning model that could generate and/or release information associated with the conversion plan based on the conversion plan itself and/or the analysis information (e.g., pattern identification, impact assessment) from the preparatory module 115. For example, the post-implementation module 118 may transmit alert notifications according to the alert procedures to a respective computing device 150A. Details and exemplary embodiments relating to generating information by the post-implementation module 118 are further discussed below in relation to FIG. 6

A dashboard module 120 may output, display, and/or otherwise provide the conversion plan or the generated information associated with the conversion plan. The dashboard may present this information in an interactive and user-friendly format, enabling users to visualize key aspects of the migration process, such as timelines, resource allocation, identified dependencies, and testing milestones. Additionally, the dashboard may include features for monitoring real-time progress, managing notifications, and facilitating collaboration among cross-functional teams.

A chatbot module 122 may include a chatbot for interactive queries related to the conversion plan. The chatbot module 122 may comprise a variety of chatbots with different personas tailored to different skill levels and positions, such as support engineers, development engineers, technical leadership, and business leadership. Each chatbot persona is designed to provide customized responses, with high-level overviews for leadership roles, detailed technical insights for engineers, and contextual guidance for operational staff. The chatbot may leverage generative AI models and natural language processing to respond to queries in real time, offer step-by-step troubleshooting assistance, and provide updates on the migration or upgrade process.

As an illustrative example, technical leadership might ask, “What are the key milestones outlined in the conversion plan?” The chatbot may respond with a high-level overview, such as, “The conversion plan for migrating the on-premises application to the cloud includes three main milestones: 1) Data mapping and validation, scheduled for completion by January 15th; 2) Environment setup and testing, scheduled for January 30th; and 3) Final migration and post-migration testing, scheduled for February 15th.” In contrast, the response to the same query from an individual identified as a development engineer may include both the three main milestones and a plurality of additional development targets leading to each of the three main milestones.

A model training module 124 and a model operation module 126, respectively, may train and operate machine learning models, such as neural networks, generative AI models, and language models (LMs). The model training module 124 prepares machine learning models at different modules using different inputs. For example, the model training module 124 may train each AI preprocessor module in the plurality of preprocessor modules 114 to preprocess different types of input data 112. In another example, the model training module 124 may train the integration AI models in the preprocessing module 114 using a plurality of preprocessed inputs to determine pattern identifications of past conversions and an impact assessment. In yet another example, the model training module 124 may train the implementation AI models in the implementation module 116 using the impact assessment and/or pattern identifications to determine, for example, an architecture framework of the new application, the timeline for the migration or the upgrade, etc.

The migration computing system 110 may employ one or more neural network models (e.g., a combination of models or a multimodal model) to process images (e.g., diagrams) and text (e.g., documents), extracting relevant information and classifying the information into categories such as by asset. One or more evaluation metrics of the models and/or the migration computing system 110 system may be used to continuously improve the performance of the migration computing system 110 and/or models.

In some aspects, the model training module 124 may pre-train a model and/or fine-tune a model. In some aspects, such pre-training and/or fine-tuning may be performed using a cloud platform/API such as Large Language Models (LLMs) fine-tuning of a commercially-available model such as OpenAI's GPT (Generative Pre-trained Transformer). LMs can assist in generating code, generating reports, interpreting complex data sets, and summarizing technical documents, among other things. The LMs can enhance productivity, improve code quality, and accelerate the development cycle of AI models for migration. This technical stack, enriched with LM capabilities, may be used to provide a foundation for effectively managing the challenges associated with automating migration or upgrades of software applications.

The NIC 106 may include any suitable network interface controller(s), such as wired/wireless controllers (e.g., Ethernet controllers), and facilitate bidirectional/multiplexed networking over the network between the computing environment 100 and other components or systems. The network may be a single communication network or may include multiple communication networks of one or more types (e.g., one or more wired and/or wireless local area networks (LANs), and/or one or more wired and/or wireless wide area networks (WANs) such as the Internet).

The migration computing system 110 may include, and/or be communicatively coupled to (e.g., via the network 140), at least one electronic database 130. The database 130 may include a relational database, such as Oracle, DB2, MySQL, a NoSQL database such as MongoDB, and/or another suitable database. The database 130 may store various types of information to automate migration or upgrades of software applications. The database 130 may store the input data 112, the application data 113, and/or other data associated with the existing application.

The network 140 may communicatively couple components and/or devices of the computing environment 100. The network 140 may include both physical and virtual components that together enable the transmission of data throughout the computing environment 100. The physical components of the network 140 may include one or more servers that store and process data, routers and switches that direct data traffic, and cabling and/or wireless technology infrastructure that links these devices. The virtual components of the network 140 may include software such as network operating systems, network management tools, and communication protocols that ensure data is transmitted securely and arrives at its intended destination within the computing environment 100. The network 140 may enable user interaction with the computing environment 100 through various interfaces, such as applications, dashboards, chatbots, etc., allowing the user to input data, configure settings, and view outputs like reports and dashboards (e.g., via one or more APIs (not depicted)).

The computing environment 100 may be logically divided to include a migration environment 160A, and one or more technology ecosystems 160B, according to some embodiments. The migration environment 160A may include the migration computing system 110 and its components. The technology ecosystems 160B may include one or more components that are utilized to transmit and/or receive information regarding the conversion or the new application based upon the conversion plan. The one or more technology ecosystems 160B may include one or more computing devices 150A, one or more computing systems 150B, and/or one or more computing networks 150C. Of course, the one or more technology ecosystems 160B may include more or fewer (or different) components, such as operating systems, applications, and development tools that enable devices to perform tasks and provide functionality to users; network infrastructure including local area networks (LAN), wide area networks (WAN), the internet, and wireless networks; data that is processed, stored, and transmitted by the computing ecosystem, including databases, data warehouses, and big data platforms; security components such as encryption software/devices, firewalls, and antivirus software; cloud/remote servers and services that provide scalable computing resources, storage, and applications over the internet; middleware such as APIs and message brokers/queues; user interfaces including graphical user interfaces (GUIs), command-line interfaces (CLIs), and voice interfaces; hardware and solutions for saving data, such as hard drives, solid-state drives (SSDs), network-attached storage (NAS), and cloud storage; integration services; support/maintenance services including technical support, software updates, and hardware maintenance; and standards and protocols. Any of the foregoing devices, services, networks, etc. may contribute to receiving information regarding the conversion or the new application based upon the conversion plan.

One or more components of the computing environment 100 may be implemented as cloud-based services. For example, the electronic database 130 may be hosted on a cloud platform such as Amazon Web Services (AWS), Google Cloud Platform (GCP), or Microsoft Azure, leveraging scalable storage solutions and managed database services like Amazon RDS or Google Cloud SQL. This cloud-based implementation allows for dynamic scaling to accommodate varying loads and data volumes, ensuring that the system can efficiently handle the extensive data analysis required for automating migration or upgrades of software applications. Additionally, the model training module 124 and the model operation module 126 may utilize cloud-based machine learning and AI services, such as AWS SageMaker or Google AI Platform, to train and deploy sophisticated models to automate migration or upgrades of software applications. A cloud-based approach may provide the flexibility and computational power needed to process large datasets and apply complex algorithms, enhancing the system's ability to deliver real-time insights. It should be appreciated that the computing environment 100 may utilize a public cloud, such as AWS, GCP, or Azure, to leverage their infrastructure and services for scalability and flexibility. Alternatively, a private cloud may be employed, offering more control over the environment and potentially enhanced security for sensitive data. A hybrid cloud approach may also be adopted, combining the benefits of both public and private clouds by keeping certain critical operations and data on-premises or in a private cloud for security and compliance reasons, while utilizing the public cloud for scalable computing resources and advanced services. A hybrid model may provide a balanced approach, optimizing the system's performance and security based on the specific needs for automating migration or upgrades of software applications.

The migration computing system 110 may generate, via the post implementation module 118, information regarding the conversion or the new application based upon the conversion plan. The migration computing system 110 may output at least a portion of the information at an electronic dashboard via the dashboard module 120. The dashboard may be dynamically generated, provide information on the conversion plan, dependency information (e.g., notification to users that will be impacted by the conversion), potential maintenance information, release notes, etc. The migration computing system 110 may additionally provide or otherwise employ a chatbot via the chatbot module 122 for providing user interaction respective to queries related to the conversion plan. The chatbot may provide the user with detailed information associated with the conversion plan. The migration computing system 110 may generate one or more notifications and/or tasks associated with the conversion plan via post-implementation module 118. The migration computing system 110 may provide (e.g., via the dashboard) or otherwise transmit (e.g., via the network 140 to a computing device 150A) the notifications and/or tasks to one or more devices in the technology ecosystems 160B.

Potential actors using the computing environment 100 could include application owners, risk management teams, cybersecurity teams, enterprise resiliency groups and other cross-functional teams within an organization. These actors interact with the computing environment through various computing devices or systems in the technology ecosystems 160B, which may be individual servers, a cluster of multiple servers, laptops, desktop computers, or cloud-based virtualization services. These devices or systems are connected to the computing environment 100 via the network 140, enabling the seamless exchange of data and insights. For example, a cybersecurity team may transmit a query to the chatbot 122 of the migration computing system 110 regarding the conversion plan via the computing device 150A through the network 140, and receive an answer from the chatbot 122 through the network 140 via the computing device 150A. In some embodiments, the migration computing system 110 may directly transmit information regarding migration or upgrades of software applications to the computing device 150A.

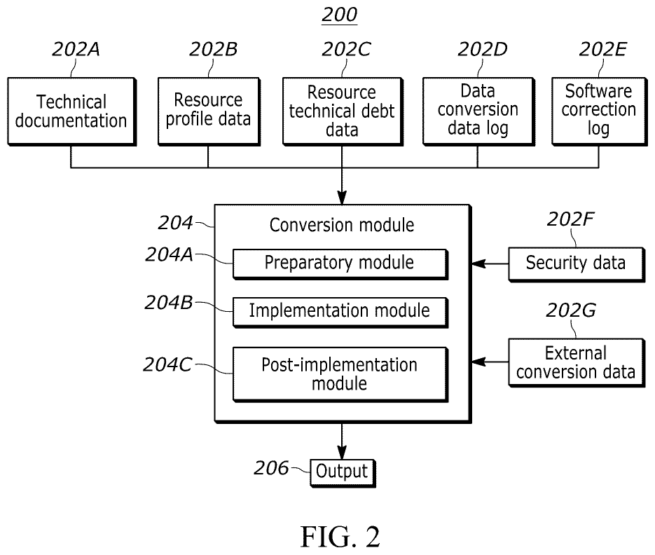

FIG. 2 depicts a block diagram of an example computer-implemented method 200 for automating migration or upgrades of an existing application to a new application, according to some embodiments. The method 200 may include processing technical documentation (block 202A), resource profile data (block 202B), resource technical debt data (block 202C), a data conversion data log (block 202D), a software correction log (block 202E), security data (block 202F), and external conversion data (block 202G). These data may be associated with the existing application.

The method 200 may obtain a plurality of preprocessed data from blocks 202A, 202B, 202C, 202D, 202E, 202F, and 202G. A conversion module (block 204) may migrate an existing application to a new application using the plurality of preprocessed data. The conversion module (block 204) may comprise a preparatory module 204A (corresponding to preparatory module 115 of FIG. 1), an implementation module 204B (corresponding to implementation module 116 of FIG. 1), and a post-implementation module 204C (corresponding to post-implementation module 118 of FIG. 1). The method 200 may include generating an output 206. The output 206 may comprise information regarding the conversion or the new application based upon the conversion plan. Details and examples of each block in the FIG. 2 are further described below and, for various blocks, in relation to FIGS. 3A-7.

FIG. 3A depicts a block flow diagram of an example computer-implemented method 202A for codifying technical documentation associated with an existing application, according to some embodiments. The technical documentation may be a collection of materials that describe the design, functionality, configuration, and operation of a system or application. The method 300A generally corresponds to block 202A of the method 200 of FIG. 2. The method 300A may process technical documentation inputs and generate reports using artificial intelligence. The method 300A may include receiving technical documentation inputs associated with the existing application including technical documents (block 302A), code repositories (block 304A), architecture diagrams (block 306A), system configurations (block 308A), and process flows (block 310A).

Technical documents (block 302A) may include manuals, specifications, and guidelines that provide a detailed description of the existing application's functionality, design, and dependencies. Code repositories (block 304A) may store the source code, version history, and associated libraries of the existing application. Architecture diagrams (block 306A) may offer a visual representation of the existing application's structural design, showcasing components, interconnections, and dependencies, which are essential for understanding how changes in one part of the system may impact others. System configurations (block 308A) may define the operational settings and parameters of the existing application, including hardware specifications, network configurations, and middleware settings, which may be evaluated for compatibility during migration. Process flows (block 310A) may illustrate the workflows and sequences of operations within the existing application, helping to identify critical paths, bottlenecks, or inefficiencies that could be addressed during the migration or upgrade process.

A technical AI preprocessor module (block 311A) may comprise a neural network (block 312A) and a generative AI (block 314A). The neural network may receive the technical documentation inputs from blocks 302A, 304A, 306A, 308A, 310A and in response classify the technical documentation inputs by resources (e.g., assets) (block 312A). For example, in an IT infrastructure context, the existing application may be a platform utilizing, hosting, or interacting with various infrastructure assets, such as servers, virtual machines (VMs), databases, and network components. The neural network may classify inputs related to each infrastructure asset, such as technical documentation detailing server configurations, code repositories containing scripts for managing VMs, architecture diagrams illustrating relationships between network components and firewalls, system configurations defining storage and compute allocations, and process flows describing data backup and recovery operations. Each classification may group related information by individual infrastructure assets, such as “Database Server A,” “Web Server B,” or “Virtual Machine Cluster C,” enabling downstream processes to analyze and plan migrations or upgrades efficiently.

Following the classification, the method 300A may include generating one or more reports by the generative AI model (block 314A), resulting in codified technical information (block 316A), or preprocessed technical documentation. The generative AI model synthesizes the classified technical documentation inputs into structured, standardized formats suitable for downstream processing. In some embodiments, based on the codified technical information 316A, the technical AI preprocessor module (block 311A) may perform a reinforcement learning to improve the neural network 312A and the generative AI model 314A.

FIG. 3B depicts a block flow diagram of an example computer-implemented method 300B for codifying resource profile data (e.g., asset details) associated with the existing application, according to some embodiments. The resource profile data may be a detailed inventory of resources, including information such as asset types, configurations, ownership, dependencies, usage patterns, etc. The method 300B generally corresponds to block 202B of the method 200 of FIG. 2. The method 300B may process resource profile inputs and generate reports using artificial intelligence. The method 300B may include receiving resource profile inputs including the resource details 302B.

Resource details 302B may include critical information about each resource within the existing application, such as its type (e.g., database or application server), version information, ownership details (e.g., technical and product owners), data classification (e.g., public, confidential, or restricted), dependencies, disaster recovery (DR) plans, associated risks, and end-of-life timelines. For example, in an IT infrastructure platform hosting various assets, the resource details for “Database Server A” might specify that it runs on PostgreSQL version 12.3, has a dependency on a load balancer for handling traffic, is classified as confidential due to sensitive user data, and includes a disaster recovery plan that involves daily snapshots and replication to a secondary data center.

A resource profile AI preprocessor module 311B may comprise a neural network (block 312B) and a generative AI model (block 314B). The neural network may receive the resource profile inputs from block 302B and in response classify the resource details by resources (e.g., assets) (block 312B). Following the classification, the method 300B may include generating one or more reports by the generative AI model (block 314B), resulting in codified resource information (block 316B), or preprocessed resource profile data. The generative AI model may synthesize the classified resource profile inputs into structured, standardized formats suitable for downstream processing. In some embodiments, based on the codified resource information 316B, the resource profile AI preprocessor module 311B may perform reinforcement learning to improve the neural network 312B and the generative AI model 314B.

The resource technical debt data (block 202C), or technical debt assessment, may comprise a detailed evaluation of the current state of the application or system, identifying areas where technical debt exists and quantifying its impact on performance, security, and maintainability. Technical debt may refer to the accumulated cost of suboptimal design decisions, outdated technologies, or deferred maintenance that hinders a system's functionality, scalability, or compliance. This assessment may involve analyzing legacy codebases, identifying deprecated frameworks or libraries, reviewing system configurations for inefficiencies, and pinpointing architectural flaws. In some embodiments, the migration computing system 110 may use a neural network to classify the technical debt data by resources (e.g., assets) and generate one or more reports by using a generative AI model, resulting in codified technical debt information (or preprocessed technical debt data).

An exemplary method to determine a technical debt assessment is detailed in U.S. Patent Application 18/889583, entitled “ANALYSIS AND CLASSIFICATION METHODS AND SYSTEMS FOR ASSESSING, IDENTIFYING, AND TRACKING TECHNICAL DEBT IN ORGANIZATIONS,” which was filed on Sep. 19, 2024, and is incorporated herein by reference in its entirety. The technical debt assessments may assess technical debt within a technology ecosystem (e.g., of an organization) and identify areas for technical debt improvement. The technical debt assessments may include actionable strategies based on the assessment of technical debt, such as a detailed report of technical debts by applications, a report of technical debts by business functions, an interactive chatbot for stakeholder engagement, and a dashboard for visualizing technical debt data and progress in addressing identified debts, etc.

FIG. 3C depicts a block flow diagram of an example computer-implemented method 300C for codifying data conversion incident log (e.g., incident report), according to some embodiments. The data conversion incident log may be a record of issues encountered during past data migration or conversion processes. The method 300C generally corresponds to block 202D of the method 200 of FIG. 2. The method 300C may process data conversion incident log inputs and generate reports using artificial intelligence. The method 300C may include receiving the data conversion incident log inputs associated with the existing application including incident platforms (block 302C) and project management platforms (block 304C).

The incident platforms (block 302C) may provide detailed records of issues encountered during the lifecycle of the existing application, particularly during prior migrations or upgrades. These platforms may capture critical data, such as the type of incidents (e.g., performance issues, compatibility errors, or security vulnerabilities), their root causes, remediation steps undertaken, and the time required for resolution. Common tools like JIRA and ServiceNow serve as centralized repositories for tracking and managing these incidents. The project management platforms (block 304C) may contain data related to the planning, execution, and oversight of prior migration or upgrade projects for the existing application. These platforms store information such as task assignments, resource allocation, timelines, dependencies, and the overall status of the project.

A data conversion AI preprocessor module (block 311C) may comprise a neural network (block 312C) and a generative AI (block 314C). The neural network may receive the data conversion incident log inputs from blocks 302C and 304C, and in response classify the data conversion incident log inputs by resources (e.g., assets) (block 312C). Following the classification, the method 300C may include generating one or more reports by the generative AI model (block 314C), resulting in codified data conversion incident log information (block 316C), or a preprocessed data conversion incident log. The generative AI model may synthesize the classified data conversion incident log inputs into structured, standardized formats suitable for downstream processing. In some embodiments, based on the codified data conversion incident log information 316C, the data conversion AI preprocessor module (block 311C) may perform reinforcement learning to improve the neural network 312C and the generative AI model 314C.

FIG. 3D depicts a block flow diagram of an example computer-implemented method 300D for codifying software correction log (e.g., bug reports), according to some embodiments. The software correction log may be a detailed record of identified software issues, including descriptions of the problem, steps to reproduce it, affected components, and the resolution or workaround implemented. Method 300D generally corresponds to block 202E of the method 200 of FIG. 2. The method 300A may process software correction log inputs and generate reports using artificial intelligence. The method 300A may include receiving technical documentation inputs associated with the existing application including one or more incident platform (block 302D), project management platform (block 304D), and resource documentations (block 306D).

The incident platform 302D and the project management platform 304D may be as described in the incident platform 302C and the projection management platform 304C in FIG. 3C. The resource documentation 306D may provide detailed inventory of resources associated with the existing application, such as hardware components, software modules, databases, and third-party tools. These inputs include specifications, version information, end-of-life details, disaster recovery plans, ownership assignments, and associated risks.

A software correction AI preprocessor module 311D may comprise a neural network (block 312D) and a generative AI model (block 314D). The neural network may receive the software correction log inputs from blocks 302D and 304D, and in response classify the software correction log inputs by resources (e.g., assets) (block 312D). Following the classification, the method 300D may include generating one or more reports by the generative AI model (block 314D), resulting in codified software correction log information (block 316D), or a preprocessed software correction log. The generative AI model may synthesize the classified software correction log inputs into structured, standardized formats suitable for downstream processing. In some embodiments, based on the codified software correction log information 316D, the software correction AI preprocessor module 311D may perform reinforcement learning to improve the neural network 312D and the generative AI model 314D.

FIG. 3E depicts a block flow diagram of an example computer-implemented method 300E for codifying security data associated with an existing application, according to some embodiments. The security data may be information related to the security measures, vulnerabilities, and overall readiness of the existing application, including details from scans, compliance assessments, and implemented safeguards to ensure protection against potential threats. The method 300E generally corresponds to block 202F of the method 200 of FIG. 2. The method 300E may process security data inputs and generate reports using artificial intelligence. The method 300E may include receiving security inputs including one or more CI/CD pipeline (block 302E) and security posture (block 304E).

The CI/CD pipeline (block 302E) may provide security insights by detecting vulnerabilities in the application's code, dependencies, and configurations during the software development lifecycle. The CI/CD pipeline may typically include static code analysis, dynamic application security testing, and dependency checks to identify risks such as outdated libraries, insecure configurations, or exploitable code patterns. The security posture (block 304E) may encompass an overall assessment of the application's security readiness and capabilities, including implemented security measures, identified vulnerabilities, compliance with industry standards, and existing guardrails. It may also consider operational practices, such as access control policies, encryption methods, and disaster recovery plans.

A security AI preprocessor module 311E may comprise a neural network (block 312E) and a generative AI model (block 314E). The neural network may receive the security inputs from blocks 302E and 304E and, in response, classify the security inputs by resources (e.g., assets) (block 312E). Following the classification, the method 300E may include generating one or more reports by the generative AI model (block 314E), resulting in codified security information (block 316E), or preprocessed security data. The generative AI model synthesizes the classified security inputs into structured, standardized formats suitable for downstream processing. In some embodiments, based on the codified security information 316E, the security AI preprocessor module 311E may perform reinforcement learning to improve the neural network 312E and the generative AI model 314E.

FIG. 3F depicts a block flow diagram of an example computer-implemented method 300F for codifying external conversion data associated with an existing application, according to some embodiments. The external conversion data may be information from external sources, including web resources, vendor documentation, and subscription details, that provide guidance, requirements, and constraints for the migration or upgrade of the existing application. Method 300F generally corresponds to block 202G of the method 200 of FIG. 2. The method 300F may process external conversion data and generate reports using artificial intelligence. The method 300F may include receiving external conversion inputs associated with the existing application including one or more web sources (block 302F), vendor information (block 304F), and subscription information (block 306F).

The web sources (block 302F) may provide external information about the migration or upgrade process, including publicly available knowledge bases, forums, FAQs, or documentation related to the existing application. These inputs may include best practices, common issues encountered during similar conversions, and community-driven solutions. The vendor information (block 304F) may include details provided by the application or tool vendors, such as product documentation, support resources, release notes, and compatibility guidelines. These inputs may outline recommended upgrade paths, deprecation warnings, or integration requirements for the application. The subscription information (block 306F) may relate to licensing or service agreements associated with the existing application, including subscription plans, renewal dates, and usage limits. These inputs may identify any constraints or opportunities for optimization, such as upgrading to a more cost-effective plan or ensuring that the application's subscription terms align with the planned migration or upgrade.

An external AI preprocessor module 311F may comprise a neural network (block 312F) and a generative AI model (block 314F). The neural network may receive the external conversion inputs from blocks 302F, 304F, and 306F and in response classify the external conversion inputs by resources (e.g., assets) (block 312F). Following the classification, the method 300F may include generating one or more reports by the generative AI model (block 314F), resulting in codified external conversion information (block 316F), or preprocessed external conversion data. The generative AI model synthesizes the classified external conversion inputs into structured, standardized formats suitable for downstream processing. In some embodiments, based on the codified external conversion information 316F, the external AI preprocessor module 311F may perform reinforcement learning to improve the neural network 312F and the generative AI model 314F.

FIG. 4 depicts a block flow diagram of a preparatory stage of preparing and assessing preprocessed data 402 from the preprocessing stages (from FIG. 3A-3F) associated with the existing application. The method 400 generally corresponds to preparatory module 204A of the method 200 of FIG. 2. In some embodiments, the preparatory stage may include the preprocessing stages of FIGS. 3A-3F. The preprocessed data may include preprocessed technical documentation (from FIG. 3A and corresponding to block 202A), preprocessed resource profile data (from FIG. 3B and corresponding to block 202B), preprocessed technical debt data (corresponding to block 202C), preprocessed data conversion incident log (from FIG. 3C and corresponding to block 202D), preprocessed software correction log (from FIG. 3D and corresponding to block 202E), preprocessed security data (from FIG. 3E and corresponding to block 202F), and preprocessed external conversion data (from FIG. 3F and corresponding to block 202G).

Integration AI models 403 may comprise a neural network (block 404), a generative AI model (block 406), and a reinforcement learning model (block 408). The neural network (block 404) may receive the preprocessed data 402 and determine a pattern identification of a past conversion of the existing application such as strategies used in prior migrations and upgrades, including blue-green deployments to minimize downtime by maintaining parallel environments during the transition, or phase-wise upgrades executed in sequential waves (e.g., Wave 1, Wave 2, and Wave 3) to manage complexity and reduce risk. These identified patterns may provide insights into best practices and common challenges, enabling the system to tailor the migration or upgrade plan to the specific needs and constraints of the existing application. By analyzing these patterns, the neural network (block 404) can optimize the conversion process, ensuring greater reliability and efficiency.

The generative AI model (block 406) may then determine an impact assessment based on the pattern identification from the neural network (block 402) and/or the preprocessed data 402. This impact assessment may determine and/or analyze a plurality of dependencies of the existing application (e.g., system components) and their potential effects on various stakeholders during the migration or upgrade process. For example, the model may identify how changes in the application's infrastructure could affect end-users, system administrators, development teams, and business leaders. By assessing these impacts, the generative AI model helps to develop a comprehensive testing plan that ensures critical functionalities are validated, minimizes disruptions, and addresses identified risks.

The impact assessment may also consider broader implications, such as compliance requirements, data integrity, and operational continuity, ensuring that all potential risks are addressed proactively. By incorporating these insights, the generative AI model (block 406) may enhance collaboration and ensures that all affected parties are prepared for the migration or upgrade.

The method 400 may output the pattern identification of the past conversion of the existing application and the impact assessment of the migration or upgrade process (block 410). In some embodiments, the method 400 may output the plurality of dependencies of the existing application. In some further embodiments, the method 400 may employ the reinforcement learning with human feedback (block 408) to improve the neural network (block 404) and the generative AI (block 406) model.

FIG. 5 depicts a block flow diagram of an implementation stage according to some embodiments. The method 500 generally corresponds to the implementation module 204B of the method 200 of FIG. 2. FIG. 5 may include input 502 comprising the preprocessed data (block 402), pattern identification (block 410), impact assessment (block 410), and/or a plurality of dependencies of an existing application (block 410), and implementation AI models (block 503) comprising a first generative AI model 504, a second generative AI model 506, a third generative AI model 508, and a fourth generative AI model 510. The method 500 may generate a conversion plan for a conversion of the existing application to a new application. The conversion plan may comprise an architecture framework, a conversion timeline, a conversion resource management, and/or a conversion testing plan.

The first generative AI model (block 504) may use the input 502 to determine the architecture framework of the new application. The architecture framework may define the structural design, guidelines, and principles for the new application, aligning it with industry standards and best practices. The architecture framework may ensure that it adheres to established architecture standards, such as modularity, scalability, and security, while being tailored to the specific requirements of the new application. For instance, the architecture framework may specify whether the new application will follow a microservices architecture or a monolithic structure, include recommendations for load balancing, or define data storage and retrieval mechanisms. It may also incorporate considerations for cloud-native deployments, containerization, or hybrid setups, depending on the operational needs and goals of the organization.

Additionally, the architecture framework may serve as a blueprint for system components and their interactions, ensuring a cohesive design that facilitates maintainability, future upgrades, and seamless integration with existing systems. By leveraging best practices, such as the use of reusable modules, standardized APIs, and secure communication protocols, the architecture framework may provide a robust foundation for building the new application.

The second generative AI model (block 506) may use the input 502 and/or the architecture framework to generate the conversion timeline. The conversion timeline may outline a sequence of tasks required to execute the migration or upgrade, providing clear deadlines, task prioritization, and responsibilities for each team or individual involved. The timeline includes key milestones, such as data migration, testing phases, deployment steps, and post-migration validation, ensuring that all critical activities are accounted for and properly scheduled.

This timeline may additionally outline the sequence of tasks required for the migration or upgrade, specifying deadlines (e.g., associated time), task priorities, and dependencies. Each task within the conversion timeline may be linked to corresponding JIRA tickets or similar project management tools, enabling seamless tracking and resolution of issues. Notifications may also be integrated into the conversion timeline, ensuring that responsible teams and stakeholders are informed of their assignments, deadlines, and interdependencies.

For instance, the conversion timeline may include a task for configuring the target environment, linked to a JIRA ticket assigned to the infrastructure team, with notifications sent to ensure they are aware of the task and its priority. Similarly, dependencies such as the completion of development tasks before testing begins may be clearly identified within the conversion timeline. These connections allow for real-time monitoring, accountability, and proactive resolution of potential bottlenecks.

By incorporating these elements, the conversion timeline may become a dynamic and actionable roadmap that not only organizes the migration or upgrade process but also ensures clear communication, alignment across teams, and efficient execution of the plan. It provides a comprehensive framework for coordinating efforts, meeting deadlines, and achieving the desired outcomes with minimal disruption.

The third generative AI model (block 508) may use the input 502, the architecture framework, and/or the conversion timeline to generate the conversion resource management (e.g., throttling) or conversion resource management plan. Throttling during the migration or upgrade refers to controlling the rate at which resources, such as computing power, network bandwidth, or system processes, are utilized to ensure that critical operations are not disrupted. For example, the AI model may allocate limited bandwidth to migration tasks during peak business hours to prioritize user-facing operations while increasing resource usage during off-peak times to expedite the migration process.

The throttling mechanism may include limiting the number of simultaneous database transactions or application requests to prevent system overloads during the transition. The third generative AI model may leverage historical (e.g., past) traffic patterns of the existing application to determine optimal resource allocation, ensuring a balance between migration efficiency and operational stability. By analyzing past traffic data of the existing application, the third generative AI model may predict peak usage periods and allocate resources accordingly, avoiding potential bottlenecks or overuse of system resources during critical times. This approach may ensure that essential services remain available to end-users while minimizing the risk of downtime, system crashes, or performance degradation.

The fourth generative AI model (block 510) may use the input 502, the architecture framework, the conversion timeline, and/or the conversion resource management to generate the conversion testing plan. The conversion testing plan may outline a comprehensive strategy for validating the migration or upgrade, ensuring all components of the application function correctly in the new environment. The conversion testing plan may validate the conversion by a sequence of validations actions including regression testing to verify that previously working features remain unaffected, component testing to validate individual modules or subsystems, and/or integration testing to ensure seamless interaction between interconnected components.

Additionally, the conversion testing plan may incorporate vulnerability scans to identify and address potential security risks that may arise during or after the migration. In some embodiments, the fourth generative AI model may prioritize testing tasks based on the criticality of components and dependencies identified in the architecture framework and conversion timeline. It may also include pre-defined test cases, performance benchmarks, and acceptance criteria to streamline the validation process.

By generating a robust conversion testing plan, the fourth generative AI model may ensure that all potential issues are identified and mitigated before the migration is finalized, reducing the risk of errors, downtime, or disruptions to business operations.

The implementation AI models (block 503) may output the conversion plan (block 514) comprising the architecture framework, the conversion timeline, the conversion resource management, and/or the conversion testing plan. In some embodiments, the implementation AI models (block 503) may employ a reinforcement learning with human feedback (block 512) to improve the first generative AI model (block 504), the second generative AI model (block 506), the third generative AI model (block 508), and/or the fourth generative AI model (block 510).

As illustrated in FIG. 6, in some embodiments, the migration computing system 110 may execute a plurality of steps outlined in the conversion plan to migrate or upgrade the existing application to the new application prior to generating information in the post-implementation stage. This execution involves the coordinated efforts of various teams responsible for implementing the migration tasks, guided by the detailed instructions and dependencies defined in the conversion plan.

The migration computing system 110 may output, display, or otherwise provide the conversion plan through a dashboard, allowing users to view and interact with the information about the conversion plan. The dashboard presents a clear and organized interface, enabling stakeholders to easily access details such as task timelines, dependencies, and assigned responsibilities. Additionally, the migration computing system 110 may generate a communication agent (e.g., chatbot) by applying a chatbot AI model to the conversion plan. This communication agent allows users, via a computing device 150A, to interactively query and retrieve specific information about the conversion plan. For instance, users can ask questions about task deadlines, dependency resolutions, or progress updates, and the chatbot provides real-time responses tailored to their queries.

FIG. 6 depicts a block flow diagram of an example post-implementation stage according to some embodiments. The method 600 generally corresponds to the post-implementation module 204C of the method 200 of FIG. 2. FIG. 6 may include input 602 comprising the preprocessed data (block 402), pattern identification (block 410), impact assessment (block 410), a plurality of dependencies (block 410), and/or a conversion plan (block 514). The method 600 may generate post-implementation information 606 (corresponding to output 206 of FIG. 2) regarding the conversion or the new application. The information may include release notes, alert procedures, and/or maintenance procedures of the migration or upgrades.

The post-implementation module 604 may similarly comprise release AI models including a generative AI model and/or neural network model similar to the preparatory stage of FIG. 4 and the implementation stage of FIG. 5. In some embodiments, the post-implementation module 604 may be a predefined algorithm or function that generates information regarding the conversion based on the input 602.

The post-implementation module 604 may determine release notes, alert procedures, and/or maintenance procedures based on the input 602. Release notes may outline the planned changes and their implications, providing users (e.g., stakeholders) with a clear understanding of what to expect following the migration or upgrade. These notes describe anticipated modifications, such as new features, workflow changes, or deprecated functionalities, ensuring users and teams can prepare for the transition. For example, the release notes may clarify how a task performed in Version A will be executed differently in Version B, based on the proposed changes in the conversion plan.

Alert procedures may define how and when notifications will be sent during the migration process to ensure the users remain informed and can respond promptly to critical events. For instance, alerts may be planned to notify teams of key milestones, potential risks, or dependencies requiring attention. In some embodiments, the method 600 may transmit the alerts (e.g., notifications) based on the alert procedures to the users (e.g., via computing device 150A) informing them of the potential impacts and changes following the migration or upgrades.

Maintenance procedures may provide a framework for post-migration support, ensuring that any issues arising in the new application environment can be effectively addressed. This includes generating playbooks and runbooks that outline step-by-step instructions for resolving anticipated issues or performing routine maintenance tasks. For example, the maintenance procedures may address how to troubleshoot compatibility errors or monitor performance metrics in the upgraded application. These procedures also guide support teams on how to manage changes to workflows, such as adapting processes from Version A to Version B, ensuring a smooth operational transition.

The method 600 may generate post-implementation information (block 606) comprising the release notes, alert procedures, and/or maintenance procedures of the migration or upgrades. In some embodiments, the method 600 may employ a reinforcement learning with human feedback to improve its machine learning models to generate more accurate, context-aware, and actionable outputs.

FIG. 7 displays a block flow diagram of how the output 702 may be displayed. The output 702 may include generated information from a post-implementation stage of FIG. 6, a conversion plan from an implementation stage of FIG. 5, pattern identification, impact assessment, and/or a plurality of dependencies from a preparatory stage of FIG. 4, and/or preprocessed data sets of FIG. 3. The output 702 may generally correspond to output 206 of FIG. 2.

The output 702 may be displayed through a dashboard 704, corresponding to dashboard 120 of FIG. 1, or accessed via a chatbot 706, corresponding to chatbot 122 of FIG. 1. The migration computing system 110 may generate the chatbot 706, or communication agent, by applying a chatbot AI model to the output 702. The chatbot allows users to interactively query the system about specific aspects of the migration process, such as task statuses, identified dependencies, or post-implementation details, and provides real-time responses tailored to their queries. The users may access the chatbot, or a communicative agent, via a computing device 150A through the network 140. Similarly, the dashboard 704 presents the output 702 in an interactive and user-friendly format, offering features like task tracking, visualizations of dependencies, and summaries of impact assessments. This dual-mode presentation, via both chatbot and dashboard, ensures that users can access and interact with the migration data in a manner that best suits their preferences and roles, fostering greater understanding and collaboration throughout the migration lifecycle. In some embodiments the migration computing system 110 may transmit the output 702 directly to users (via computing device 150A).

In some embodiments, upon determining the output 702, the migration computing system 110 may execute part or all of the migration or upgrade process using the detailed information contained in the output 702. This output serves as a comprehensive guide, incorporating data from all stages of the migration lifecycle, including the conversion plan, pattern identifications, impact assessments, dependencies, and preprocessed datasets. By leveraging this information, the migration computing system 110 may ensure that each step of the migration is executed in alignment with the predefined strategies and objectives outlined in the conversion plan.

The migration computing system 110 may allocate resources, schedule tasks, and coordinate efforts across teams based on the dependencies and timelines specified in the output 702. For example, the system may prioritize critical tasks, such as database migrations or application server configurations, while ensuring that dependencies, such as resolving coding issues or completing preliminary testing, are addressed first.

In further embodiments, upon determining the output 702, the migration computing system 110 may serve as the central system guiding the migration or upgrade process, though it does not necessarily execute the migration itself. Instead, the migration computing system 110 may generate detailed output 702, which serves as a comprehensive guide for teams throughout the organization to carry out the migration or upgrade tasks. This output consolidates critical information, such as the conversion plan, pattern identifications, impact assessments, dependencies, and preprocessed datasets, providing a structured roadmap for implementation. For example, in some such embodiments, the detailed output 702 may include a detailed sequence of actions, commands, code, or pseudo-code to be performed or used by individuals to carry out the migration or upgrade tasks.

The output 702 enables various teams, such as infrastructure, development, and operations, to coordinate and perform their respective tasks in alignment with the predefined strategies and objectives. For instance, the infrastructure team might use the output to configure the target environment, while the development team resolves dependencies or updates application components. Similarly, the quality assurance team may leverage testing plans within the output to validate the migration's success. The migration computing system supports this process by providing ongoing guidance through the dashboard and chatbot interfaces, ensuring that all teams have access to the information they need to complete their tasks effectively.

This approach ensures flexibility, allowing the migration or upgrade to be executed by different teams across the organization while still benefiting from the structured and automated planning provided by the migration computing system 110. By relying on the system's output, teams can work collaboratively and efficiently, minimizing risks such as miscommunication, task redundancy, or delays, and ensuring a smooth transition to the new application environment.

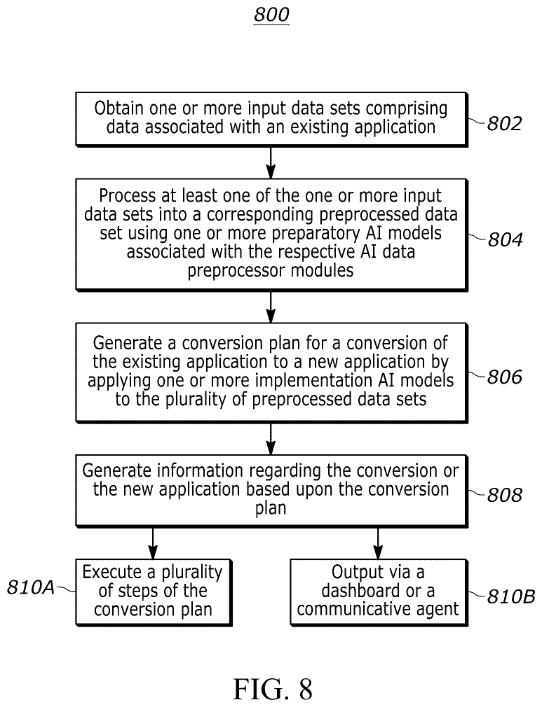

FIG. 8 depicts a computer-implemented method for automating migration or upgrades of software applications. The method may comprise a preparatory stage, an implementation stage, and a post-implementation stage for automating migration or upgrades according to some embodiments. Although the method 800 is described below with regard to a migration computing system 110 and components thereof as illustrated in FIG. 1, it will be understood that other similarly suitable devices and/or components may be used instead and that hardware systems, components, or infrastructure may additional or alternative be migrated or upgraded.

At block 802 during the preparatory stage, the migration computing system 110 may obtain one or more input data sets comprising data associated with an existing application. The data may include at least technical documentation associated with the existing application, resource profile data associated with the existing application, and security data associated with the existing application. In some embodiments, the data may further include resource technical debt data, a software correction log, data conversion incident log, external conversion data, or any other data discussed herein.

At block 804 during the preparatory stage, the migration computing system 110, for each of a plurality of artificial intelligence (AI) preprocessor modules, process at least one of the one or more input data sets into a corresponding preprocessed data set using one or more preparatory AI models associated with the respective AI data preprocessor modules. In some embodiments, the migration computing system 110, upon determining the preprocessed data set, determine pattern identifications of past conversions of different resources including at least a pattern identification of a past conversion of the existing application and an impact assessment by applying an integration AI models to the one or more preprocessed data sets.

In some embodiments, at least one of the AI preprocessor modules comprises a classifier AI model to classify the corresponding at least one input data set and a generative AI model to generate the corresponding preprocessed data set as a codified set of data for analysis by the one or more implementation AI models.

At block 806 during the implementation stage, the migration computing system 110 may generate a conversion plan for a conversion of the existing application to a new application by applying one or more implementation AI models to the plurality of preprocessed data sets, which conversion plan may comprise an architecture framework associated with the new application and a timeline for the conversion. In some embodiments, generating the conversion plan includes generating the conversion plan for the conversion of the existing application to the new application comprising at least an architecture framework associated with the new application by applying the one or more implementation AI models to the one or more preprocessed data sets, the pattern identification, and the impact assessment.

In further embodiments, the conversion plan may further comprise a conversion timeline laying out a sequence of tasks required for the conversion, a conversion resource management plan based on past network traffic data of the existing application, and a conversion testing plan to validate the conversion by a sequence of validation actions. Each respective task of the sequence of tasks may have an associated time. In yet further embodiments, the migration computing system 110 may further identify a plurality of dependencies of the existing application during the preparatory stage, and the conversion plan may be based in part upon the plurality of dependencies.

At block 808 during the post-implementation stage, the migration computing system 110 may generate information regarding the conversion or the new application based upon the conversion plan. In some embodiments, generating the information includes generating the information regarding the conversion or the new application by applying one or more release AI models to the one or more preprocessed data sets and the conversion plan. In further embodiments, the information may further comprise alert procedures and maintenance procedures, and the migration computing system 110 may transmit alert notifications according to the alert procedures.

At block 810A, the migration computing system 110 may execute a plurality of steps of the conversion plan to migrate or upgrade the existing application to the new application on one or more computing devices.

At block 810B, the migration computing system 110 may generate a communication agent by applying a chatbot AI model to the information, the conversion plan, and/or the one or more preprocessed data sets, wherein the communication agent includes a plurality of different communication modes for different users. The migration computing system 110 may then employ the communication agent to a user query regarding the conversion to generate a response. In some embodiments, the migration computing system 110 may display the information, the conversion plan, and/or the one or more preprocessed data sets on dashboard.

### Additional Considerations

The following considerations also apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

It should also be understood that, unless a term is expressly defined in this patent using the sentence “As used herein, the term” “is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112(f).

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for implementing the concepts disclosed herein, through the principles disclosed herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for automating migration or upgrades of software applications, comprising:
a preparatory stage, comprising:
obtaining, by one or more processors, one or more input data sets comprising data associated with an existing application, the data including at least technical documentation associated with the existing application, resource profile data associated with the existing application, and security data associated with the existing application; and
for each of a plurality of artificial intelligence (AI) preprocessor modules, processing, by the one or more processors, at least one of the one or more input data sets into a corresponding preprocessed data set using one or more preparatory AI models associated with the respective AI data preprocessor modules;
an implementation stage, comprising:
generating, by the one or more processors, a conversion plan for a conversion of the existing application to a new application by applying one or more implementation AI models to the plurality of preprocessed data sets, the conversion plan comprising at least an architecture framework associated with the new application and a timeline for the conversion; and
a post-implementation stage, comprising:
generating, by the one or more processors, information regarding the conversion or the new application based upon the conversion plan.

2. The method of claim 1, wherein the one or more input data sets further comprises resource technical debt data, a software correction log, data conversion incident log, and external conversion data.

3. The method of claim 1, the preparatory stage further comprising:
determining, by the one or more processors, pattern identifications of past conversions of different resources including at least a pattern identification of a past conversion of the existing application and an impact assessment by applying an integration AI models to the one or more preprocessed data sets.

4. The method of claim 3, wherein:
generating the conversion plan includes generating the conversion plan for the conversion of the existing application to the new application comprising at least an architecture framework associated with the new application by applying the one or more implementation AI models to the one or more preprocessed data sets, the pattern identification, and the impact assessment.

5. The method of claim 1, wherein the conversion plan further comprises a conversion timeline laying out a sequence of tasks required for the conversion, wherein each respective task of the sequence of tasks has an associated time.

6. The method of claim 1, wherein the conversion plan further comprises a conversion resource management plan based on past network traffic data of the existing application.

7. The method of claim 1, wherein the conversion plan further comprises a conversion testing plan to validate the conversion by a sequence of validation actions.

8. The method of claim 1, wherein:
generating the information includes generating the information regarding the conversion or the new application by applying one or more release AI models to the one or more preprocessed data sets and the conversion plan.

9. The method of claim 1, wherein the information further comprises alert procedures and maintenance procedures.

10. The method of claim 9, further comprising:
transmitting, by the one or more processors, alert notifications according to the alert procedures.

11. The method of claim 1, further comprising:
generating, by the one or more processors, a communication agent by applying a chatbot AI model to the information, the conversion plan, and/or the one or more preprocessed data sets, wherein the communication agent includes a plurality of different communication modes for different users;
employing, by the one or more processors, the communication agent to a user query regarding the conversion to generate a response.

12. The method of claim 1, wherein the preparatory stage further comprises:
identifying, by the one or more processors, a plurality of dependencies of the existing application; and
wherein the conversion plan is based in part upon the plurality of dependencies.

13. The method of claim 1, wherein the implementation stage further comprises:
executing, by the one or more processors, a plurality of steps of the conversion plan to migrate or upgrade the existing application to the new application on one or more computing devices.

14. The method of claim 1, wherein at least one of the AI preprocessors modules comprises a classifier AI model to classify the corresponding at least one input data set and a generative AI model to generate the corresponding preprocessed data set as a codified set of data for analysis by the one or more implementation AI models.

15. A computer system for automating migration or upgrades of software applications, comprising:
one or more processors, and
a tangible, non-transitory memory coupled to the one or more processors and storing executable instructions that, when executed by the one or more processors, causes the computer system to:
in a preparatory stage:
obtain one or more input data sets comprising data associated with an existing application, the data including at least technical documentation associated with the existing application, resource profile data associated with the existing application, and security data associated with the existing application; and
for each of a plurality of artificial intelligence (AI) preprocessor modules, process at least one of the one or more input data sets into a corresponding preprocessed data set using one or more preparatory AI models associated with the respective AI data preprocessor modules;
in an implementation stage:
generate a conversion plan for a conversion of the existing application to a new application by applying one or more implementation AI models to the plurality of preprocessed data sets, the conversion plan comprising at least an architecture framework associated with the new application and a timeline for the conversion; and
in a post-implementation stage:
generate information regarding the conversion or the new application based upon the conversion plan.

16. The computer system of claim 15, wherein the one or more input data sets further comprise resource technical debt data, a software correction log, data conversion incident log, and external conversion data.

17. The computer system of claim 15, wherein the instructions, when executed by the one or more processors, further causes the computer system to, in the preparatory stage:
determine pattern identifications of past conversions of different resources including at least a pattern identification of a past conversion of the existing application and an impact assessment by applying an integration AI models to the one or more preprocessed data sets.

18. A non-transitory computer-readable medium storing executable instructions for automating migration or upgrades of software applications that, when executed by one or more processors, causes the one or more processors to:
in a preparatory stage:
obtain one or more input data sets comprising data associated with an existing application, the data including at least technical documentation associated with the existing application, resource profile data associated with the existing application, and security data associated with the existing application; and
for each of a plurality of artificial intelligence (AI) preprocessor modules, process at least one of the one or more input data sets into a corresponding preprocessed data set using one or more preparatory AI models associated with the respective AI data preprocessor modules;
in an implementation stage:
generate a conversion plan for a conversion of the existing application to a new application by applying one or more implementation AI models to the plurality of preprocessed data sets, the conversion plan comprising at least an architecture framework associated with the new application and a timeline for the conversion; and
in a post-implementation stage:
generate information regarding the conversion or the new application based upon the conversion plan.

19. The non-transitory computer-readable medium of claim 18, wherein the one or more input data sets further comprise resource technical debt data, a software correction log, data conversion incident log, and external conversion data.

20. The non-transitory computer-readable medium of claim 18, wherein the instructions further cause the one or more processors to, in the preparatory stage:
determine pattern identifications of past conversions of different resources including at least a pattern identification of a past conversion of the existing application and an impact assessment by applying an integration AI models to the one or more preprocessed data sets.
